(19) United States
(12) Patent Application Publication
(10) Pub. No.: US 2012/0166507 A1
(43) Pub. Date: Jun. 28, 2012

(54) METHOD AND APPARATUS OF PERFORMING FAST FOURIER TRANSFORM

(75) Inventors: Jung Bo SON, Daejeon-si (KR); Hun Sik KANG, Deajeon-si (KR); Sok Kyu LEE, Daejeon-si (KR)

(73) Assignee: Electronics and Telecommunications Research Institute, Daejeon-si (KR)

(21) Appl. No.: 13/028,644

(22) Filed: Feb. 16, 2011

(30) Foreign Application Priority Data
Dec. 22, 2010 (KR) 10-2010-0132185

(51) Int. Cl. G06F 17/14

(52) U.S. Cl. 708/404

(57) ABSTRACT

Disclosed are a method and apparatus of performing a fast Fourier transform (FFT). The apparatus include a plurality of single-path delay feedback (SDF) butterfly blocks which performs butterfly operations, respectively; a plurality of memories which are connected to the SDF butterfly blocks, respectively; and a controller which controls the plurality of SDF butterfly blocks, wherein the plurality of SDF butterfly blocks are connected in a pipeline structure and thus output from one SDF butterfly block is input to a following SDF butterfly block.

### CROSS-REFERENCE TO RELATED APPLICATIONS

This application claims the benefit of priority of Korean Patent application No. 10-2010-0132185 filed on Dec. 22, 2010, which is incorporated by reference in their entirety herein.

### BACKGROUND OF THE INVENTION

1. Field of the Invention

The present invention relates to signal processing, and more particularly, to a method and apparatus of performing a fast Fourier transform (FFT).

2. Related Art

Recently, lots of systems have introduced orthogonal frequency division multiplexing (OFDM) technologies. The OFDM technologies can decrease inter-symbol interference (ISI) with low complexity. The OFDM converts data symbols input in series into N parallel data symbols and transmits them as being carried by N divided subcarriers, respectively. The subcarriers have to keep orthogonality in a frequency domain. The respective orthogonal channels experience frequency selective fading independently of each other, so that complexity at a receiving terminal can be decreased and space between symbols to be transmitted can be prolonged, thereby minimizing the ISI.

The OFDM system needs a lot of fast Fourier transforms (FFT) because of its own characteristics. In particular, the FFT in a wireless communication system needs a large point, and requires a function of high performance/low power. Accordingly, various techniques may be applied in order to perform the FFT. A single/dual memory structure uses one butterfly operator and a memory bank and is thus advantageous to decrease complexity of hardware in the FFT. However, it is disadvantageously difficult to use the single/dual memory structure because of high operation frequency and complex memory addressing. A parallel processing method can increase a total performance gain (throughput) through parallel processing, but it is hard to apply the parallel processing method to the FFT of the large point.

Accordingly, in a system requiring continuous and fast operations like the OFDM system, the FFT having a pipeline structure may be performed. The pipeline structure has been widely used when performing the FFT in a wireless communication system since it is proper to the FFT of the large point, its hardware control is relatively simple and it employs a regular structure.

Meanwhile, in the FFT using the pipeline structure, order of an input bit string and an output bit string may be reversed. The bit string, the order of which is reversed, may be reordered in the same order as the input bit string by a reordering buffer or the like. For the reordering, all output bit strings have to be output, and thus general delay may occur in the pipeline structure. Also, even though only data of some channels is used among the outputs of the FFT, it has to be waited until all the output bit strings are output, thereby causing the delay.

Accordingly, there is a need for a method of efficiently performing the FFT.

### SUMMARY OF THE INVENTION

The present invention provides a method and apparatus of performing a fast Fourier transform (FFT)

In an aspect, an apparatus for performing a fast Fourier transform (FFT) is provided. The apparatus includes a plurality of single-path delay feedback (SDF) butterfly blocks which performs butterfly operations, respectively; a plurality of memories which are connected to the SDF butterfly blocks, respectively; and a controller which controls the plurality of SDF butterfly blocks, the plurality of SDF butterfly blocks being connected in a pipeline structure and thus output from one SDF butterfly block being input to a following SDF butterfly block.

Each SDF butterfly block may receive 2 bits and outputs 2 bits.

The butterfly operation may be either of a first butterfly operation that performs X[0]=x[0]−x[1] and X[1]=x[0]+x[1] with regard to input values of x[0] and x[1] or a second butterfly operation X[0]=x[0]+x[1] and X[1]=x[0]−x[1] with regard to input values of x[0] and x[1].

At least one SDF butterfly block among the plurality of SDF butterfly blocks may perform the first butterfly operation, and the other SDF butterfly blocks among the plurality of SDF butterfly blocks may perform the second butterfly operation.

The SDF butterfly block performing the first butterfly operation may be a last SDF butterfly block among the plurality of SDF butterfly blocks.

With regard to a specific SDF butterfly block among the plurality of SDF butterfly blocks, a first output among outputs from the specific SDF butterfly block may be input to the memories respectively connected to the SDF butterfly blocks, and a second output among outputs from the specific SDF butterfly block may be input to the following SDF butterfly block connected to the respective SDF butterfly block.

The first output may be obtained by adding a 2-bit input of the specific SDF butterfly block, and the second output may be obtained by subtracting a 2-bit input of the specific SDF butterfly block.

The specific SDF butterfly block may include a last SDF butterfly block among the plurality of SDF butterfly blocks.

At least one SDF butterfly block among the plurality of SDF butterfly blocks may include four multiplexers (MUX).

The at least one SDF butterfly block may include a last SDF butterfly block among the plurality of SDF butterfly blocks.

The FFT may be performed in the form of decimation-in-time (DIT).

### BRIEF DESCRIPTION OF THE DRAWINGS

FIG. 1 is an example of a single-path delay feedback (SDF) structure in a pipeline fast Fourier transform (FFT).

FIG. 2 is an example of the radix-2 SDF butterfly structure.

FIG. 3 shows an example of order of outputting data in a DIF-SDF structure.

FIG. 4 shows a 16-point DIF FFT outputting data in the form of a bit-reversed order.

FIG. 5 is an example of a butterfly operation.

FIG. 6 shows another example of the SDF structure in the pipeline FFT structure.

FIG. 7 illustrates the 16-point DIT FFT having a bit-reversed order input.

FIG. 8 illustrates a subcarrier index in the FFT input and output terminals.

FIG. 9 shows an example of a timing diagram in the last SDF butterfly structure among the radix-2 SDF butterfly structures where the 16-point FFT is performed.

FIG. 10 shows an example of the butterfly operation proposed according to an exemplary embodiment of the present invention.

FIG. 11 shows an example of the last SDF butterfly structure in the radix-2 SDF structure for performing the 16-point FFT proposed according to an exemplary embodiment of the present invention.

FIG. 12 shows an example of a timing diagram in the last SDF butterfly structure of the radix-2 SDF structure for performing the 16-point FFT proposed according to an exemplary embodiment of the present invention.

FIG. 13 shows an example of a timing diagram in the last SDF butterfly structure of the radix-2 SDF structure for performing the 16-point FFT proposed according to an exemplary embodiment of the present invention.

### DESCRIPTION OF EXEMPLARY EMBODIMENTS

Hereinafter, some embodiments of the present invention are described in detail with reference to the accompanying drawings in order for those skilled in the art to be able to readily implement the invention. However, the present invention may be modified in various different ways and are not limited to the following embodiments. In order to clarify a description of the present invention, parts not related to the description are omitted, and the same reference numbers are used throughout the drawings to refer to the same or like parts. Further, a description of parts which can be easily understood by those skilled in the art is omitted.

When it is said that any part “includes (or comprises)” any constituent element, it means that the corresponding part may further include other constituent elements unless otherwise described without excluding other constituent elements.

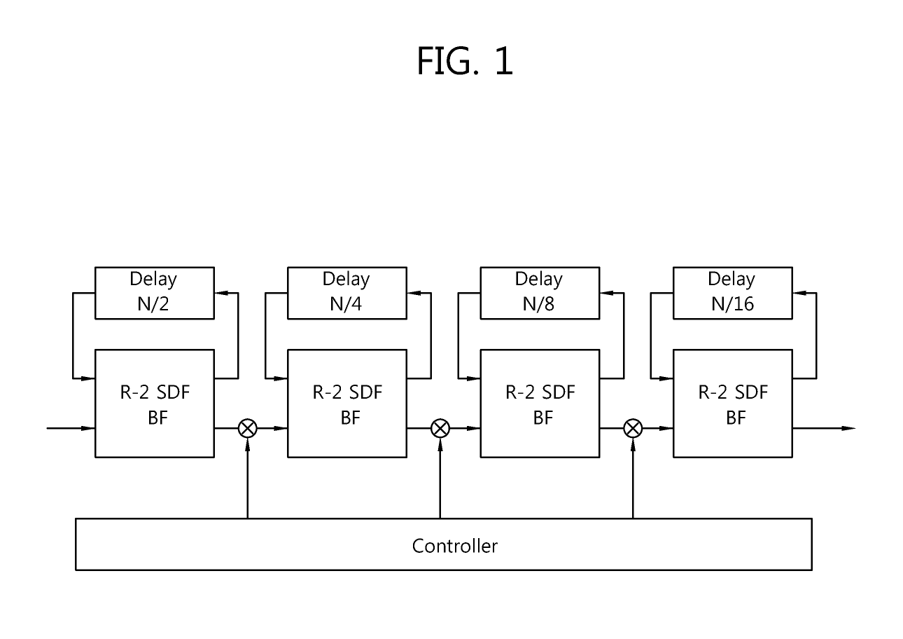

FIG. 1 is an example of a single-path delay feedback (SDF) structure in a pipeline fast Fourier transform (FFT). In the pipeline FFT structure, a butterfly operator is provided in each step and a block for reordering data is provided between the respective butterfly operators, thereby performing the FFT by a pipeline method. Here, the SDF structure is one of structures mostly applied to a communication system in the pipeline FFT structure. In the SDF structure, the output from the butterfly operator is partially stored in a feedback shift register, so that a required size of memory can be reduced. Referring to FIG. 1, a radix-2 SDF FFT structure having a point of 16 is presented. Because the point is 16, the number of needed steps is log₂16=4. Therefore, four radix-2 SDF butterfly structures are connected in the form of a pipeline.

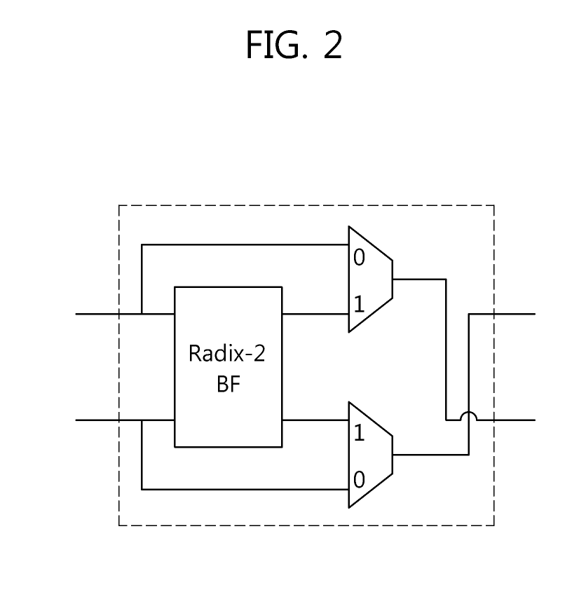

FIG. 2 is an example of the radix-2 SDF butterfly structure. The radix-2 SDF butterfly structure of FIG. 2 employs two multiplexers (MUX) for controlling data output to a first-in first-out (FIFO) memory and data output to the next radix-2 SDF butterfly structure.

Meanwhile, the SDF structure shown in FIGS. 1 and 2 corresponds to a decimation-in-frequency (DIF) FFT. The DIF FFT performs the FFT by dividing a long sequence by a short sequence in a frequency domain. On the other hand, a decimation-in-time (DIT) FFT performs the FFT by dividing a long sequence by a short sequence in a time domain. In the case of performing the DIF FFT, if continuous data is input in the time domain, data, bit order of which reversed, is output in the frequency domain. That is, the data is output in the form of bit-reversed order.

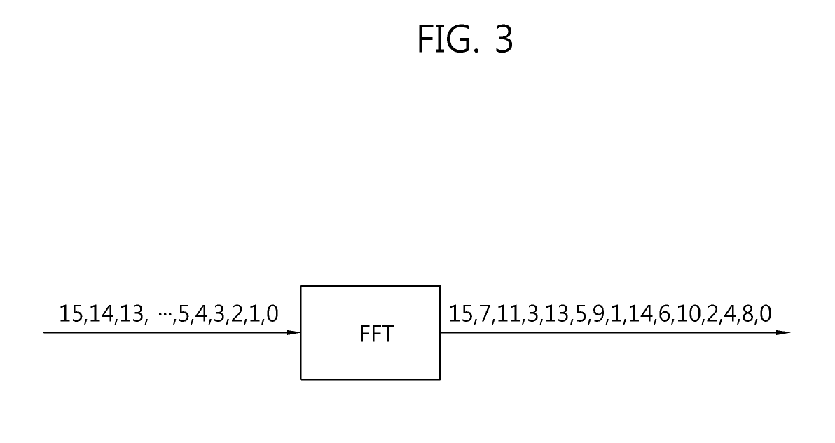

FIG. 3 shows an example of order of outputting data in the DIF-SDF structure. Referring to FIG. 3, if 0˜15 are input in order, 0, 8, 4, 12, 2, 10, 6, 14, 1, 9, 5, 13, 3, 11, 7, and 15 are output in sequence. Here, a reordering buffer or the like may be used to reorder the output data of which order is reversed. However, to reorder and output the data, it has to be waited until all the FFT outputs are completed, thereby increasing a total delay time in performing the FFT.

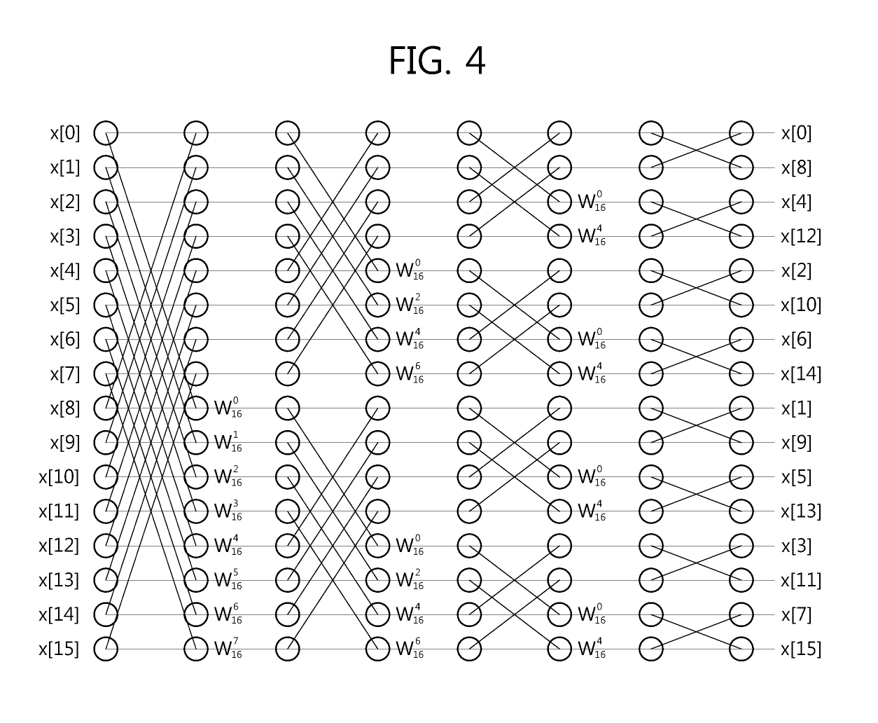

FIG. 4 shows the 16-point DIF FFT outputting data in the form of the bit-reversed order. If x[0] to x[15] are input to an input terminal in sequence, x[0], x[8], x[4], x[12], x[2], x[10], x[6], x[14], x[1], x[9], x[5], x[13], x[3], x[11], x[7] and x[15] are output from an output terminal in sequence.

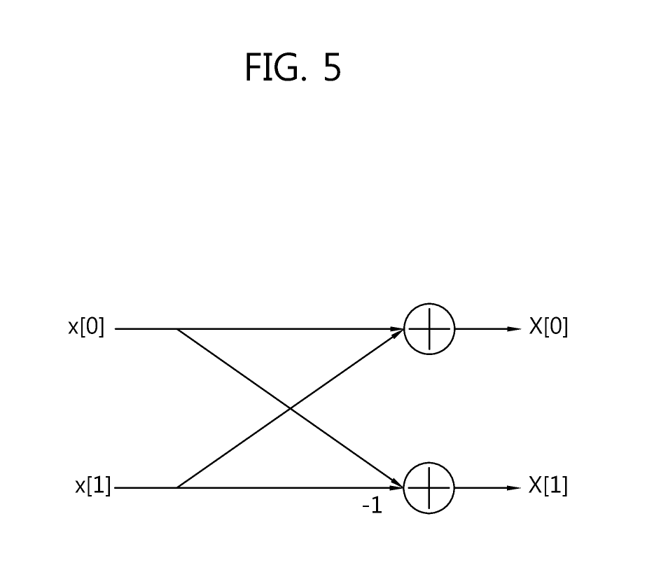

FIG. 5 is an example of a butterfly operation. The butterfly operation of FIG. 5 may be used in the DIF FFT of FIG. 4. Referring to FIG. 5, X[0]=x[0]+x[1] and X[1]=x[0]−x[1] in accordance with the butterfly operation.

To overcome the problem that signals input in order are output in the bit-reversed order, the DIT FFT may be performed so that the signal can be output in order from the output terminal by inputting the ordered input signals in the time domain in the form of bit-reversed order. Taking characteristics of an OFDM signal into account, there is a need for removing a guard interval in the frequency domain before the FFT input, and therefore it is generally possible to reverse the order of input signals with a buffer in the FFT input terminal.

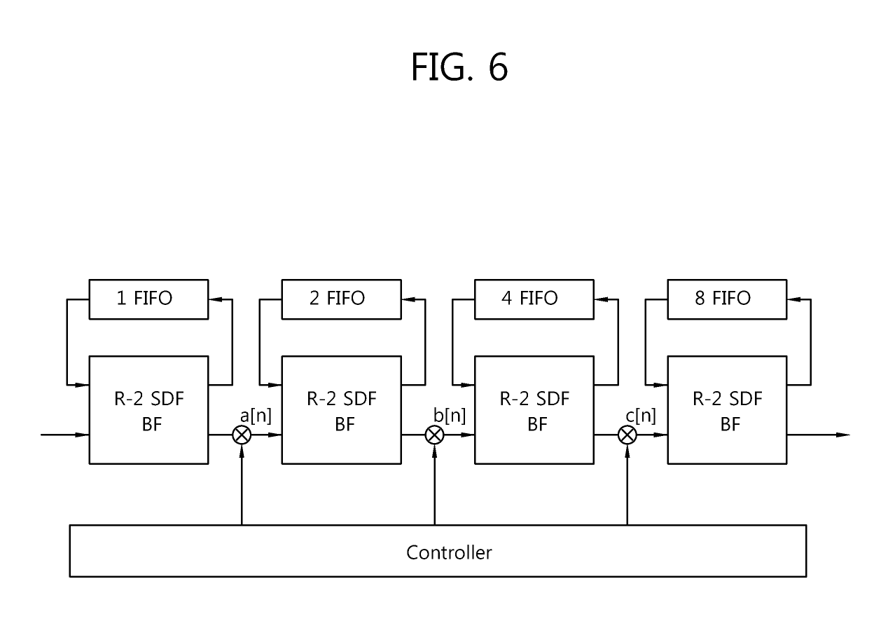

FIG. 6 shows another example of the SDF structure in the pipeline FFT structure. FIG. 6 illustrates an example of the radix-2 SDF structure using the 16-point DIT FFT.

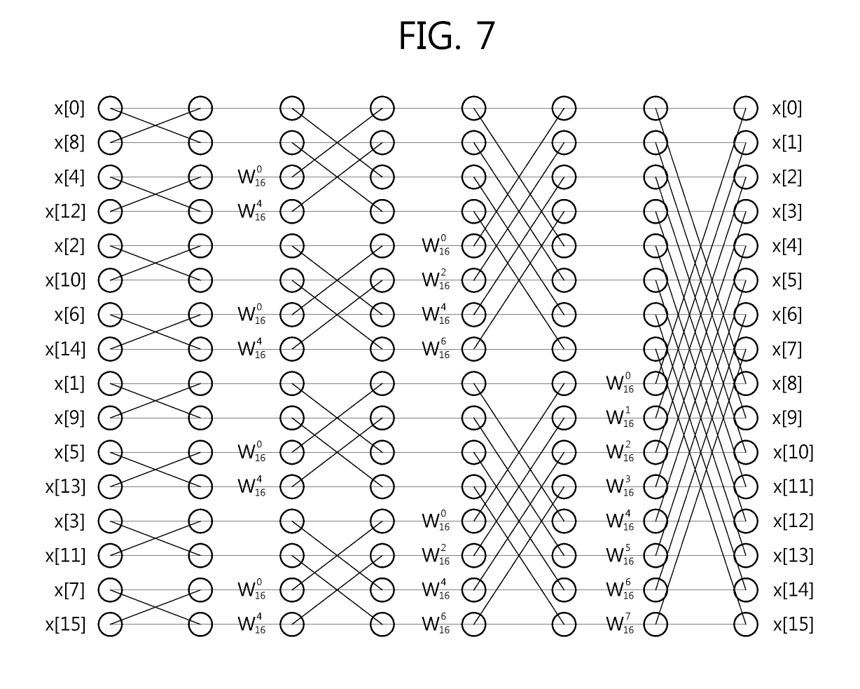

FIG. 7 illustrates the 16-point DIT FFT having a bit-reversed order input. Referring to FIG. 7, if x[0], x[8], x[4], x[12], x[2], x[10], x[6], x[14], x[1], x[9], x[5], x[13], x[3], x[11], x[7] and x[15] are input to the input terminal in sequence, x[0] to x[15] are output from the output terminal in order as opposed to those of FIG. 4.

Although the DIT FFT is performed, there is a need of waiting for all the signal outputs if only signals of some channels are used among the output signals.

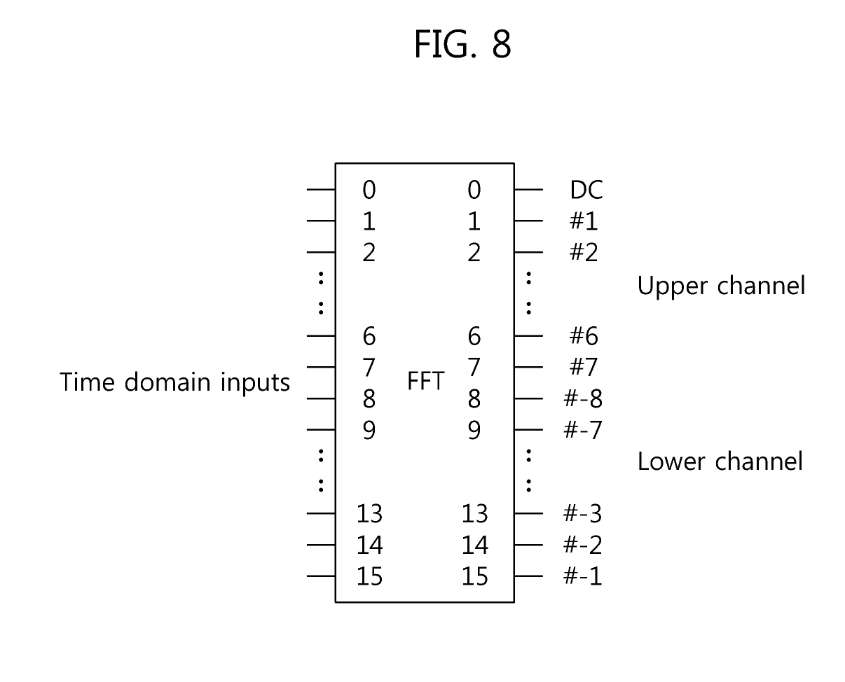

FIG. 8 illustrates a subcarrier index in the FFT input and output terminals. Referring to FIG. 8, a signal of the FFT output terminal may be divided into an upper channel and a lower channel in accordance with subcarrier indexes. The subcarrier indexes that belong to the upper channel are represented with #1 to #7, and the subcarrier indexes that belong to the lower channel are represented with #−1 to #−8.

If only the data of the lower channel is needed, it has to be waited until all signals are output in the DIF structure and it has to be waited until all data of the upper channel is output in even the DIT structure. Also, even when the upper channel and the lower channel are divided with respect to a DC subcarrier, if only one channel between the upper channel and the lower channel is needed, it has to be waited until all the signals are output in both the DIF and DIT structures. Such a problem may become more serious particularly if inputs are divided according to channels and operations are possible at both bandwidths of 40 MHz and 20 MHz like an IEEE (Institute of Electrical and Electronics Engineers) 802.11n system.

Below, a method of performing the FFT, proposed to solve the above problems, will be described. The proposed method of performing the FFT is characterized in that the structure of the last SDF is changed to minimize delay of output and efficiently detect only data of a desired channel in the case of using the pipeline SDF structure in the DIT-based FFT.

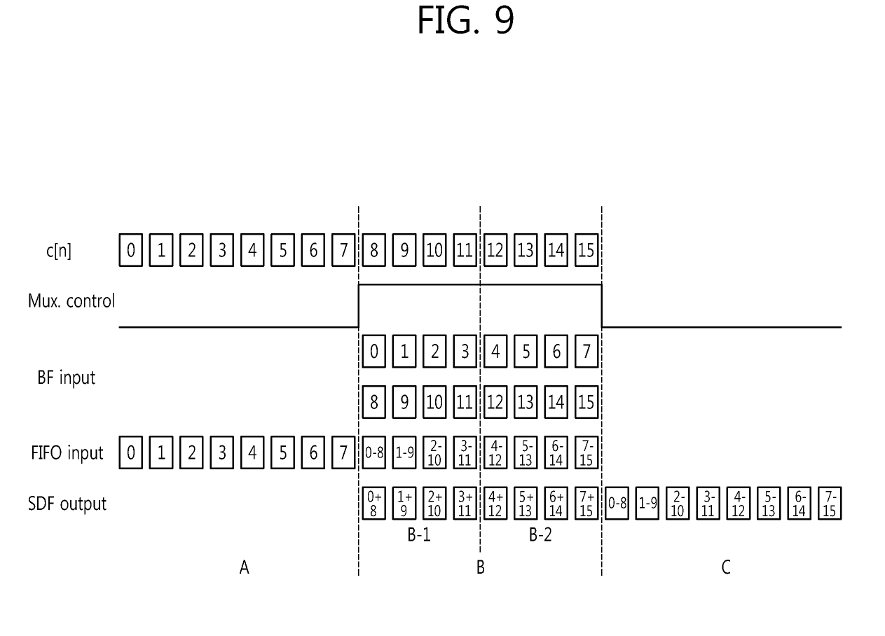

FIG. 9 shows an example of a timing diagram in the last SDF butterfly structure among the radix-2 SDF butterfly structures where the 16-point FFT is performed.

Referring to FIG. 9, c[0] to c[7] are first input and directly input to the FIFO. Then, c[8] to c[15] are input and form pairs with c[0] to c[7] stored in the FIFO, so that they can be input by an butterfly operation. At this time, the butterfly operation may use the butterfly operation of FIG. 5. Among results from performing the butterfly operation, results from performing a subtraction operation are stored in the FIFO, and results from performing an addition operation are directly output as final outputs. After the results from the addition operation are all output, the results from the subtraction operation stored in the FIFO are output. The timing diagraph of FIG. 9 can be ascertained in the last step of the radix-2 SDF structure using the 16-point DIF FFT, and signals of the lower channel is output after signals of the upper channel is output in accordance with the operations of the last SDF butterfly structure.

As a result of performing the FFT, to acquire the signals of the lower channel prior to the signals of the upper channel, a final output direction and a FIFO output direction may be exchanged with each other in the last SDF butterfly structure. In other words, the results from performing the addition operation among the results from performing the butterfly operation are stored in the FIFO, but the results from performing the subtraction operation are directly output as final outputs.

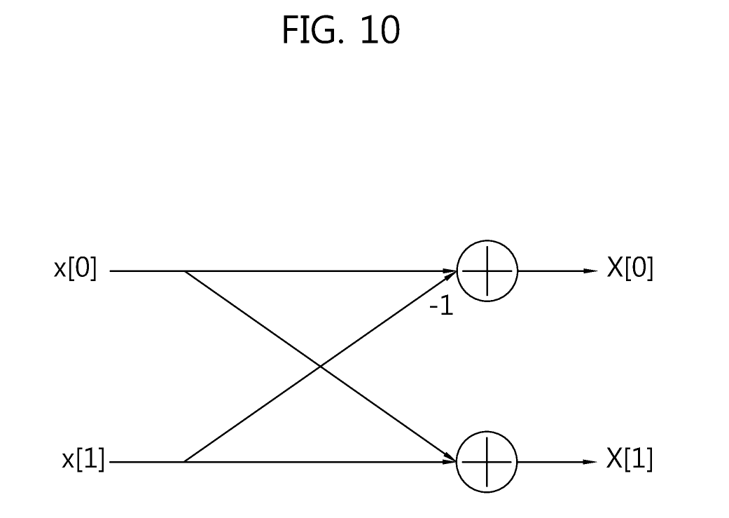

FIG. 10 shows an example of the butterfly operation proposed according to an exemplary embodiment of the present invention. Referring to FIG. 10, it will be appreciated that an addition operation direction and a subtraction operation direction are reversed as compared with those of FIG. 5. Referring to FIG. 10, X[0]=x[0]−x[1] and X[1]=x[0]+x[1] in accordance with the butterfly operation. That is, without exchanging the final output direction and the FIFO output direction with each other the in the last SDF butterfly structure, the addition operation direction and the subtraction operation direction are reversed in the butterfly operation, thereby acquiring the signals of the lower channel prior to the signals of the upper channel.

If only one between the signal of the upper channel and the signal of the lower channel is needed from the output data with respect to the DC subcarrier, it is adjusted while having a MUX value of 1 that results from the addition operation are output in the first half section B-1 and results from the subtraction operation are output in the other half section B-2, thereby acquiring a signal from only one channel with respect to the DC subcarrier.

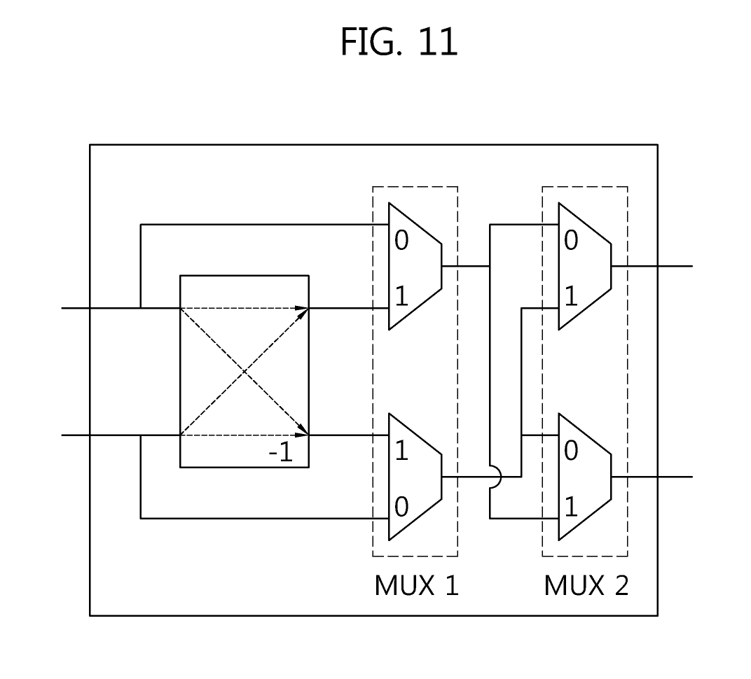

FIG. 11 shows an example of the last SDF butterfly structure in the radix-2 SDF structure for performing the 16-point FFT proposed according to an exemplary embodiment of the present invention. The last SDF butterfly structure of FIG. 11 directly uses the butterfly operation of FIG. 5, and uses a first MUX MUX 1 and a second MUX MUX 2, thereby controlling the output through the first MUX and the second MUX.

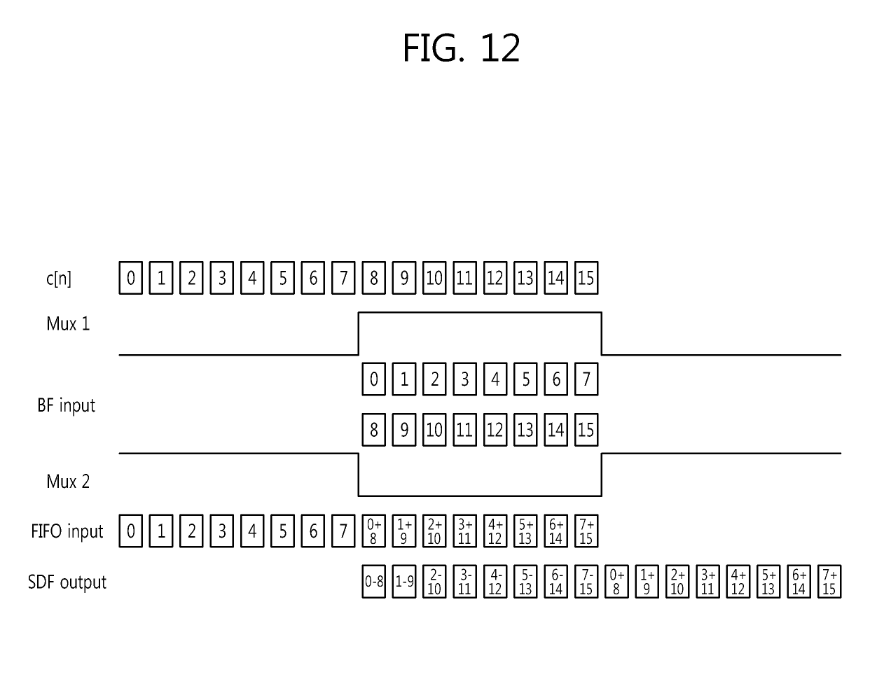

FIG. 12 shows an example of a timing diagram in the last SDF butterfly structure of the radix-2 SDF structure for performing the 16-point FFT proposed according to an exemplary embodiment of the present invention. The timing diagram of FIG. 12 corresponds to the timing diagram of when the SDF butterfly structure of FIG. 11 is applied to the last step of the FFT in the SDF structure. Referring to FIG. 12, the second MUX is controlled so that the signals of the lower channel can be acquired prior to the signals of the upper channel.

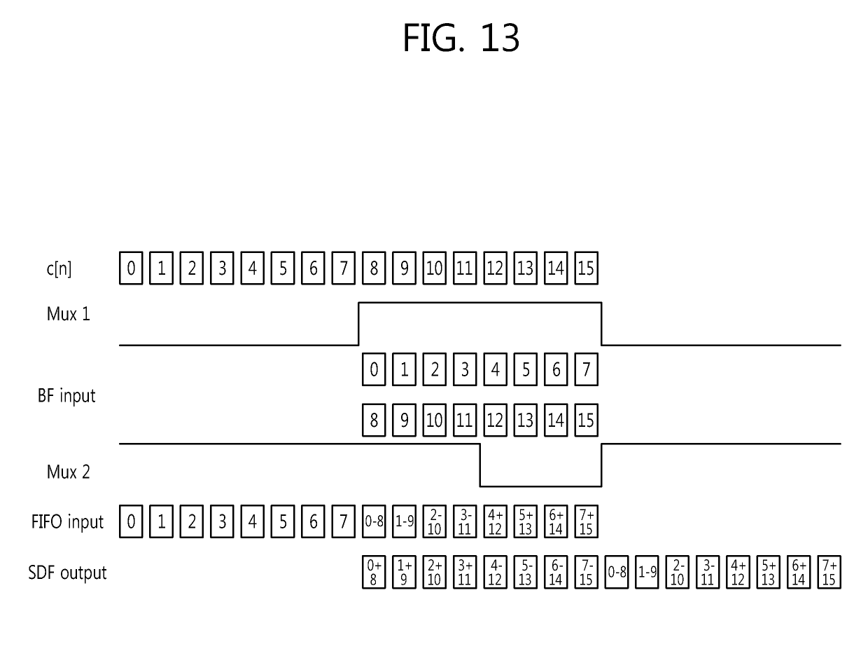

FIG. 13 shows an example of a timing diagram in the last SDF butterfly structure of the radix-2 SDF structure for performing the 16-point FFT proposed according to an exemplary embodiment of the present invention. Likewise, the timing diagram of FIG. 13 also corresponds to the timing diagram of when the SDF butterfly structure of FIG. 11 is applied to the last step of the FFT in the SDF structure. However, the second MUX is controlled differently from that of FIG. 12 so that only one between the signal of the upper channel and the signal of the lower channel can be first acquired with respect to the DC subcarrier.

As described above, the last SDF butterfly structure is changed while performing the FFT introducing the pipeline SDF structure, so that the order of outputting data can be adjusted variously. Also, the present invention is not limited to the change of the last SDF butterfly structure, and may include change of the previous SDF butterfly structure, thereby controlling the order of output signals.

As apparent from the foregoing description, in the case that a pipeline single-path delay feedback (SDF) structure is employed in a decimation-in-time (DIT) fast Fourier transform (FFT), a last SDF structure is changed to thereby minimize delay of output and efficiently detect only data of a desired channel.

The present invention can be implemented using hardware, software, or a combination of them. In the hardware implementations, the present invention can be implemented using an Application Specific Integrated Circuit (ASIC), a Digital Signal Processor (DSP), a Programmable Logic Device (PLD), a Field Programmable Gate Array (FPGA), a processor, a controller, a microprocessor, other electronic unit, or a combination of them, which is designed to perform the above-described functions. In the software implementations, the present invention can be implemented using a module performing the above functions. The software can be stored in a memory unit and executed by a processor. The memory unit or the processor can use various means which are well known to those skilled in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

What is claimed is:

1. An apparatus for performing a fast Fourier transform (FFT), the apparatus comprising:
a plurality of single-path delay feedback (SDF) butterfly blocks which performs butterfly operations, respectively;
a plurality of memories which are connected to the SDF butterfly blocks, respectively; and
a controller which controls the plurality of SDF butterfly blocks,
the plurality of SDF butterfly blocks being connected in a pipeline structure and thus output from one SDF butterfly block being input to a following SDF butterfly block.

2. The apparatus of claim 1, wherein each SDF butterfly block receives 2 bits and outputs 2 bits.

3. The apparatus of claim 1, wherein the butterfly operation is either of a first butterfly operation that performs X[0]=x[0]−x[1] and X[1]=x[0]+x[1] with regard to input values of x[0] and x[1] or a second butterfly operation X[0]=x[0]+x[1] and X[1]=x[0]−x[1] with regard to input values of x[0] and x[1].

4. The apparatus of claim 3, wherein
at least one SDF butterfly block among the plurality of SDF butterfly blocks performs the first butterfly operation, and
the other SDF butterfly blocks among the plurality of SDF butterfly blocks performs the second butterfly operation.

5. The apparatus of claim 3, wherein the SDF butterfly block performing the first butterfly operation is a last SDF butterfly block among the plurality of SDF butterfly blocks.

6. The apparatus of claim 1, wherein, with regard to a specific SDF butterfly block among the plurality of SDF butterfly blocks,
a first output among outputs from the specific SDF butterfly block is input to the memories respectively connected to the SDF butterfly blocks, and
a second output among outputs from the specific SDF butterfly block is input to the following SDF butterfly block connected to the respective SDF butterfly block.

7. The apparatus of claim 6, wherein
the first output is obtained by adding a 2-bit input of the specific SDF butterfly block, and
the second output is obtained by subtracting a 2-bit input of the specific SDF butterfly block.

8. The apparatus of claim 6, wherein the specific SDF butterfly block is a last SDF butterfly block among the plurality of SDF butterfly blocks.

9. The apparatus of claim 1, wherein at least one SDF butterfly block among the plurality of SDF butterfly blocks comprises four multiplexers (MUX).

10. The apparatus of claim 9, wherein the at least one SDF butterfly block is a last SDF butterfly block among the plurality of SDF butterfly blocks.

11. The apparatus of claim 1, wherein the FFT is performed in the form of decimation-in-time (DIT).
